(19) United States
(12) Patent Application Publication
(10) Pub. No.: US 2025/0167301 A1
(43) Pub. Date: May 22, 2025

(54) NON-AQUEOUS ELECTROLYTE AND SECONDARY BATTERY COMPRISING THE SAME

(71) Applicant: Apple Inc., Cupertino, CA (US)

(72) Inventors: Jongho Jeon, San Jose, CA (US); Hongli Dai, Los Altos, CA (US); Zhengcheng Zhang, Naperville, IL (US); Qian Liu, Bolingbrook, IL (US); James A. Gilbert, Bolingbrook, IL (US)

(21) Appl. No.: 18/945,286

(22) Filed: Nov. 12, 2024

Related U.S. Application Data
(60) Provisional application No. 63/601,116, filed on Nov. 20, 2023.

(51) Int. Cl. H01M 10/0567; H01M 10/0568; H01M 10/0569

(52) U.S. Cl. CPC H01M 10/0567; H01M 10/0568; H01M 10/0569; H01M 2300/0042

(57) ABSTRACT

This disclosure relates generally to battery cells, and more particularly, electrolyte additives for use in lithium-ion battery cells.

### PRIORITY

This patent application claims the benefit of U.S. Provisional Patent Application No. 63/601,116, entitled “NON-AQUEOUS ELECTROLYTE AND SECONDARY BATTERY COMPRISING THE SAME,” filed on Nov. 20, 2023, which is incorporated herein by reference in its entirety.

### U.S. GOVERNMENT LICENSE RIGHTS

This invention was made with U.S. government support under WFO Proposal No. 85C85. This invention was made under a CRADA 1500801 between Apple Inc. and Argonne National Laboratory operated for the United States Department of Energy. The U.S. government has certain rights in the invention.

### FIELD

This disclosure relates generally to battery cells, and more particularly, electrolyte additives for use in lithium-ion battery cells.

### BACKGROUND

Li-ion batteries are widely used as the power sources in consumer electronics. Consumer electronics use Li-ion batteries which can deliver higher volumetric energy densities and sustain more discharge-charge cycles. A Li-ion battery typically works at a voltage up to 4.45 V (full cell voltage).

Limited progress has been made in developing battery cells capable of high-speed charging.

### SUMMARY

In a first aspect, the disclosure is directed to an electrolyte fluid comprising at least 0.01 wt % of a compound selected from Formula (I), Formula (II), Formula (III), Formula (IV), and a combination thereof:

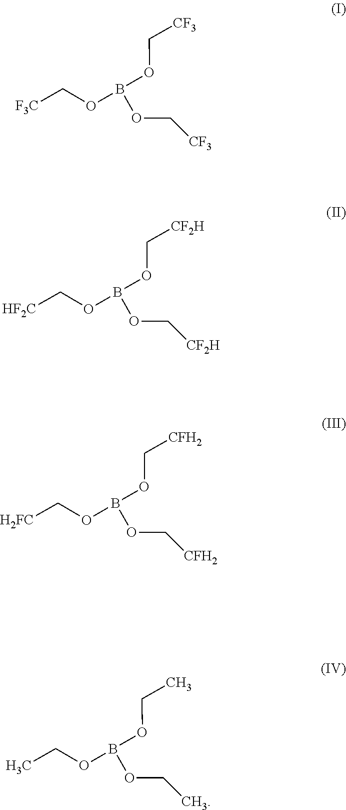

In some variations, the compound has the structure of Formula (I). In some variations, the electrolyte fluid includes a compound of Formula (I), fluoroethylene carbonate (FEC), and lithium difluoro (oxalato) borate (LiDFOB). In some variations, the electrolyte fluid excludes pro-1-ene-1, 3-sultone (PES) and methylene methanedisulfonate (MMDS).

In some variations, the electrolyte fluid includes a compound having the structure of Formula (II). In some variations, the electrolyte fluid includes a compound having the structure of Formula (III). In some variations, the electrolyte fluid includes a compound having the structure of Formula (IV).

In some variations, the electrolyte fluid can be an electrolyte salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

In some variations, the electrolyte fluid can include a solvent selected from ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), fluoroethylene carbonate (FEC), ethyl acetate (EA), propyl propionate (PP), butyl propionate (BP), propyl acetate (PA), butyl acetate (BA), and a combination thereof.

In some variations, the electrolyte fluid can include an additive selected from fluoroethylene carbonate (FEC), methylene methanedisulfonate (MMDS), pro-1-ene-1, 3-sultone (PES), propane sultone (PS), lithium difluoro (oxalato) borate (LiDFOB), succinonitrile (SN), 1,3,6-hexanetricarbonitrile (HTCN), LiBF₄, and/or in any of any of the above combination and/or ranges of amounts thereof.

In some variations, the disclosure is directed to a battery cell. The battery cell can include a cathode having a cathode active material disposed on a cathode current collector, and an anode having an anode active material disposed on an anode current collector. The anode is oriented towards the cathode such that the anode active material faces the cathode active material. A separator is disposed between the cathode active material and the anode active material. An electrolyte fluid as described herein is disposed between the cathode and anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell in accordance with an illustrative embodiment; and

FIG. 2 is a perspective view of a battery cell in accordance with an illustrative embodiment;

FIG. 3A depicts the average battery cell voltage at 50% state of charge (SOC) as a function of charge time for battery cells containing electrolyte fluids that include TFEB and that do not include TFEB, according to an illustrative embodiment;

FIG. 3B depicts anode potential as a function of charge time for battery cells containing electrolyte fluids that include TFEB and that do not include TFEB, according to an illustrative embodiment;

FIG. 3C depicts dQ/dV as a function of cell voltage for the formation of SEI on the graphite anode for battery cells containing electrolyte fluids that include TFEB and that do not include TFEB, according to an illustrative embodiment;

FIG. 4A depicts the average battery cell voltage at 50% state of charge (SOC) as a function of charge time of battery cells containing electrolyte fluids that include TFEB and that do not include TFEB, according to an illustrative embodiment;

FIG. 4B depicts the specific discharge capacity as a function of cycle number for room temperature (25° C.) fast charging cycle performance of battery cells containing electrolyte fluids that include TFEB and that do not include TFEB, according to an illustrative embodiment;

FIG. 4C depicts the specific discharge capacity as a function of cycle number for higher temperature (45° C.) fast charging cycle performance of battery cells containing electrolyte fluids that include TFEB and that do not include TFEB, according to an illustrative embodiment;

FIG. 5A depicts the full battery cell voltage at 50% state of charge (SOC) as a function of charge time of battery cells containing electrolyte fluids that include TFEB and that do not include TFEB, according to an illustrative embodiment;

FIG. 5B depicts anode potential as a function of charge time (anode overpotential) of battery cells containing electrolyte fluids that include TFEB and that do not include TFEB, according to an illustrative embodiment;

FIG. 6A depicts the average cell voltage at 50% SOC as a function of charge time to 50% SOC of battery cells having electrolyte fluids that include TFEB, DFEB, and neither TFEB nor DFEB, according to an illustrative embodiment;

FIG. 6B depicts the specific discharge capacity as a function of cycle number for room temperature (25° C.) fast charging cycle performance of battery cells having electrolyte fluids that include TFEB, DFEB, or neither TFEB nor DFEB, according to an illustrative embodiment;

FIG. 6C depicts the specific discharge capacity as a function of cycle number for different battery cells having electrolyte fluids that include TFEB, DFEB, or neither TFEB nor DFEB at higher temperature (45° C.) fast charging cycle performance, according to an illustrative embodiment;

FIG. 7A depicts specific discharge capacity as a function of cycle number following room temperature (25° C.) fast charging cycle performance for battery cells having electrolyte fluids containing DFEB and no DFEB, according to an illustrative embodiment; and

FIG. 7B depicts energy retention as a function of cycle number following room temperature (25° C.) fast charging cycle performance for battery cells having electrolyte fluids containing DFEB and no DFEB, according to an illustrative embodiment.

### DETAILED DESCRIPTION

Reference will now be made in detail to representative embodiments illustrated in the accompanying drawings. It should be understood that the following descriptions are not intended to limit the embodiments to any single embodiment or combined embodiments. To the contrary, it is intended to cover alternatives, modifications, and equivalents as can be included within the spirit and scope of the described embodiments as defined by the appended claims.

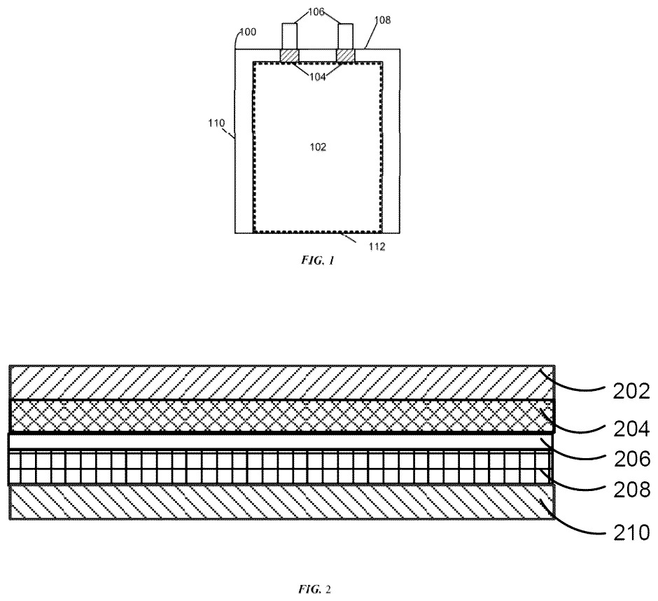

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

FIG. 2 presents a perspective view of battery cell 200 (e.g., the battery cell 100 of FIG. 1) in accordance with the disclosed embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210, and is in contact with separator 208. To create the battery cell, cathode 202, separator 208, and anode 210 may be stacked in a planar configuration, or stacked and then wrapped into a wound configuration. Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil. The cathode active material can be any material described in, for example, Ser. No. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). Other microporous polymer membranes or non-woven fabric mats are possible (e.g., gel polymer electrolytes).

In general, separators represent structures in a battery cell, such as interposed layers, that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, electrolyte fluid can act a conductive pathway for the movement of cations passing from the negative to the positive electrodes during discharge. The electrolyte fluid includes an electrolyte salt, electrolyte solvent, and one or more electrolyte additives.

The electrolyte fluid includes an additive having the structures of Formula (I), Formula (II), Formula (III), Formula (IV), or a combination thereof.

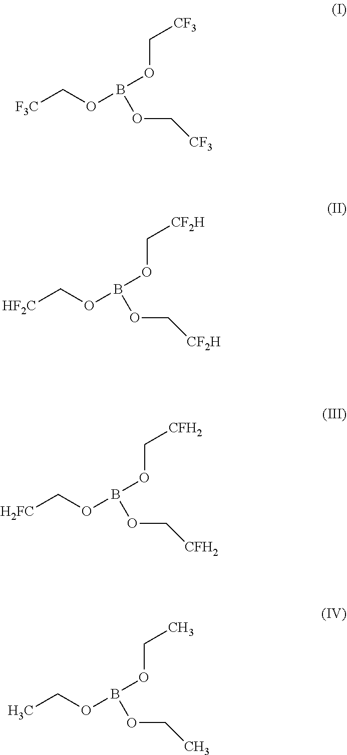

As used herein, Formula (I) is referred to alternatively as tris(2,2,2-trifluoroethyl) borate (TFEB), Formula (II) is referred to as tris(2,2-difluoroethyl) borate (DFEB), and Formula (III) is referred to as tris(2-fluoroethyl) borate (FEB), and Formula (IV) is referred to as triethyl borate (TEB).

As above, the compounds of Formulae (I)-(IV) can be alone or combined in any combination. As described herein, when a combination of the compounds of Formulae (I)-(IV) are included, each of the compounds of Formula (I)-(IV) need not be in the same amount.

In some variations, an additive selected from a compound of one or Formula (I)-(IV), or each additive in a combination of compounds of Formula (I)-(IV), is in an amount of at least 0.01 wt % of the electrolyte fluid. In some variations, an additive selected from a compound of one or Formula (I)-(IV), or each additive in a combination of compounds of Formula (I)-(IV), is in an amount of at least 0.03 wt % of the electrolyte fluid. In some variations, an additive selected from a compound of one or Formula (I)-(IV), or each additive in a combination of compounds of Formula (I)-(IV), is in an amount of at least 0.05 wt % of the electrolyte fluid. In some variations, an additive selected from a compound of one or Formula (I)-(IV), or each additive in a combination of compounds of Formula (I)-(IV), is in an amount of at least 0.07 wt % of the electrolyte fluid. In some variations, an additive selected from a compound of one or Formula (I)-(IV), or each additive in a combination of compounds of Formula (I)-(IV), is in an amount of at least 0.10 wt % of the electrolyte fluid. In some variations, an additive selected from a compound of one or Formula (I)-(IV), or each additive in a combination of compounds of Formula (I)-(IV), is in an amount of at least 0.20 wt % of the electrolyte fluid. In some variations, an additive selected from a compound of one or Formula (I)-(IV), or each additive in a combination of compounds of Formula (I)-(IV), is in an amount of at least 0.30 wt % of the electrolyte fluid. In some variations, an additive selected from a compound of one or Formula (I)-(IV), or each additive in a combination of compounds of Formula (I)-(IV), is in an amount of at least 0.50 wt % of the electrolyte fluid. In some variations, an additive selected from a compound of one or Formula (I)-(IV), or each additive in a combination of compounds of Formula (I)-(IV), is in an amount of at least 0.75 wt % of the electrolyte fluid. In some variations, an additive selected from a compound of one or Formula (I)-(IV), or each additive in a combination of compounds of Formula (I)-(IV), is in an amount of at least 1.0 wt % of the electrolyte fluid. In some variations, an additive selected from a compound of one or Formula (I)-(IV), or each additive in a combination of compounds of Formula (I)-(IV), is in an amount of at least 1.25 wt % of the electrolyte fluid. In some variations, an additive selected from a compound of one or Formula (I)-(IV), or each additive in a combination of compounds of Formula (I)-(IV), is in an amount of at least 1.50% of the electrolyte fluid. In some variations, an additive selected from a compound of one or Formula (I)-(IV), or each additive in a combination of compounds of Formula (I)-(IV), is in an amount of at least 1.75 wt % of the electrolyte fluid. In some variations, an additive selected from a compound of one or Formula (I)-(IV), or each additive in a combination of compounds of Formula (I)-(IV), is in an amount of at least 2.00 wt % of the electrolyte fluid. In some variations, an additive selected from a compound of one or Formula (I)-(IV), or each additive in a combination of compounds of Formula (I)-(IV), is in an amount of at least 2.25 wt % of the electrolyte fluid. In some variations, an additive selected from a compound of one or Formula (I)-(IV), or each additive in a combination of compounds of Formula (I)-(IV), is in an amount of at least 2.50 wt % of the electrolyte fluid. In some variations, an additive selected from a compound of one or Formula (I)-(IV), or each additive in a combination of compounds of Formula (I)-(IV), is in an amount of at least 2.75 wt % of the electrolyte fluid.

In some variations, an additive selected from a compound of one or Formula (I)-(IV), or each additive in a combination of compounds of Formula (I)-(IV), is in an amount of equal to or less than 3.00 wt % of the electrolyte fluid. In some variations, an additive selected from a compound of one or Formula (I)-(IV), or each additive in a combination of compounds of Formula (I)-(IV), is in an amount of equal to or less than 2.75 wt % of the electrolyte fluid. In some variations, an additive selected from a compound of one or Formula (I)-(IV), or each additive in a combination of compounds of Formula (I)-(IV), is in an amount of equal to or less than 2.50 wt % of the electrolyte fluid. In some variations, an additive selected from a compound of one or Formula (I)-(IV), or each additive in a combination of compounds of Formula (I)-(IV), is in an amount of equal to or less than 2.25 wt % of the electrolyte fluid. In some variations, an additive selected from a compound of one or Formula (I)-(IV), or each additive in a combination of compounds of Formula (I)-(IV), is in an amount of equal to or less than 2.00 wt % of the electrolyte fluid. In some variations, an additive selected from a compound of one or Formula (I)-(IV), or each additive in a combination of compounds of Formula (I)-(IV), is in an amount of equal to or less than 1.75 wt % of the electrolyte fluid. In some variations, an additive selected from a compound of one or Formula (I)-(IV), or each additive in a combination of compounds of Formula (I)-(IV), is in an amount of equal to or less than 1.50 wt % of the electrolyte fluid. In some variations, an additive selected from a compound of one or Formula (I)-(IV), or each additive in a combination of compounds of Formula (I)-(IV), is in an amount of equal to or less than 1.25 wt % of the electrolyte fluid. In some variations, an additive selected from a compound of one or Formula (I)-(IV), or each additive in a combination of compounds of Formula (I)-(IV), is in an amount of equal to or less than 1.00 wt % of the electrolyte fluid. In some variations, an additive selected from a compound of one or Formula (I)-(IV), or each additive in a combination of compounds of Formula (I)-(IV), is in an amount of equal to or less than 0.75 wt % of the electrolyte fluid. In some variations, an additive selected from a compound of one or Formula (I)-(IV), or each additive in a combination of compounds of Formula (I)-(IV), is in an amount of equal to or less than 0.50 wt % of the electrolyte fluid. In some variations, an additive selected from a compound of one or Formula (I)-(IV), or each additive in a combination of compounds of Formula (I)-(IV), is in an amount of equal to or less than 0.30 wt % of the electrolyte fluid. In some variations, an additive selected from a compound of one or Formula (I)-(IV), or each additive in a combination of compounds of Formula (I)-(IV), is in an amount of equal to or less than 0.20 wt % of the electrolyte fluid. In some variations, an additive selected from a compound of one or Formula (I)-(IV), or each additive in a combination of compounds of Formula (I)-(IV), is in an amount of equal to or less than 0.10 wt % of the electrolyte fluid. In some variations, an additive selected from a compound of one or Formula (I)-(IV), or each additive in a combination of compounds of Formula (I)-(IV), is in an amount of equal to or less than 0.08 wt % of the electrolyte fluid. In some variations, an additive selected from a compound of one or Formula (I)-(IV), or each additive in a combination of compounds of Formula (I)-(IV), is in an amount of equal to or less than 0.06 wt % of the electrolyte fluid. In some variations, an additive selected from a compound of one or Formula (I)-(IV), or each additive in a combination of compounds of Formula (I)-(IV), is in an amount of equal to or less than 0.04 wt % of the electrolyte fluid. In some variations, an additive selected from a compound of one or Formula (I)-(IV), or each additive in a combination of compounds of Formula (I)-(IV), is in an amount of equal to or less than 0.03 wt % of the electrolyte fluid. In some variations, an additive selected from a compound of one or Formula (I)-(IV), or each additive in a combination of compounds of Formula (I)-(IV), is in an amount of equal to or less than 0.02 wt % of the electrolyte fluid.

A lower limit or upper limit of the amount of a compound of one or Formula (I)-(IV), or each additive in a combination of compounds of Formula (I)-(IV), can be selected separately.

The electrolyte fluid includes an electrolyte solvent. The electrolyte solvent may be any type of electrolyte solvent suitable for battery cells. Non-limiting examples of the electrolyte solvents include propylene carbonate (PC), ethylene carbonate (EC), fluoroethylene carbonate (FEC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), or combinations thereof.

The electrolyte fluid also has one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], and LiC(SO₂CF₃)₃. Other salts are possible, including combinations of salts.

In some variations, the salt is at least 0.1 M in the total electrolyte fluid. In some variations, the salt is at least 0.2 M in the total electrolyte fluid. In some variations, the salt is at least 0.3 M in the total electrolyte fluid. In some variations, the salt is at least 0.4 M in the total electrolyte fluid. In some variations, the salt is at least 0.5 M in the total electrolyte fluid. In some variations, the salt is at least 0.6 M in the total electrolyte fluid. In some variations, the salt is at least 0.7 M in the total electrolyte fluid. In some variations, the salt is at least 0.8 M in the total electrolyte fluid. In some variations, the salt is at least 0.9 M in the total electrolyte fluid. In some variations, the salt is at least 1.0 M in the total electrolyte fluid. In some variations, the salt is at least 1.3 M in the total electrolyte fluid. In some variations, the salt is at least 1.6 M in the total electrolyte fluid. In some variations, the salt is at least 1.9 M in the total electrolyte fluid.

In some variations, the salt is less than or equal to 2.0 M in the electrolyte fluid. In some variations, the salt is less than or equal to 1.9 M in the electrolyte fluid. In some variations, the salt is less than or equal to 1.6 M in the electrolyte fluid. In some variations, the salt is less than or equal to 1.3 M in the electrolyte fluid. In some variations, the salt is less than or equal to 1.1 M in the electrolyte fluid. In some variations, the salt is less than or equal to 1.0 M in the electrolyte fluid. In some variations, the salt is less than or equal to 0.9 M in the electrolyte fluid. In some variations, the salt is less than or equal to 0.8 M in the electrolyte fluid. In some variations, the salt is less than or equal to 0.7 M in the electrolyte fluid. In some variations, the salt is less than or equal to 0.6 M in the electrolyte fluid. In some variations, the salt is less than or equal to 0.5 M in the electrolyte fluid. In some variations, the salt is less than or equal to 0.4 M in the electrolyte fluid. In some variations, the salt is less than or equal to 0.3 M in the electrolyte fluid. In some variations, the salt is less than or equal to 0.2 M in the electrolyte fluid.

The nitrile groups in the compound of Formula (I) can reduce anode overpotential and stabilize cathode interface through coordination. The addition of the compound of Formula (I) increases battery cell longevity. When battery cells are at higher voltage for longer period of time, degradation during electrode side degradation. The additive also can augment fast charging capability.

In some variations, the electrolyte fluid can include one or more additives. In various aspects, the additives can include fluoroethylene carbonate (FEC), methylene methanedisulfonate (MMDS), pro-1-ene-1, 3-sultone (PES), propane sultone (PS), lithium difluoro (oxalato) borate (LiDFOB), succinonitrile (SN), 1,3,6-hexanetricarbonitrile (HTCN), LiBF₄, and/or in any of any of the above combination and/or ranges of amounts thereof.

In some variations, the amount of FEC is at least 0.5 wt % of the total electrolyte fluid. In some variations, the amount of FEC is at least 1 wt % of the total electrolyte fluid. In some variations, the amount of FEC is at least 2 wt % of the total electrolyte fluid. In some variations, the amount of FEC is at least 4 wt % of the total electrolyte fluid. In some variations, the amount of FEC is at least 6 wt % of the total electrolyte fluid. In some variations, the amount of FEC is at least 8 wt % of the total electrolyte fluid. In some variations, the amount of FEC is less than or equal to 10 wt % of the total electrolyte fluid. In some variations, the amount of FEC is less than or equal to 12 wt % of the total electrolyte fluid. In some variations, the amount of FEC is less than or equal to 14 wt % of the total electrolyte fluid. In some variations, the amount of FEC is less than or equal to 16 wt % of the total electrolyte fluid. In some variations, the amount of FEC is less than or equal to 18 wt % of the total electrolyte fluid. In some variations, the amount of FEC is less than or equal to 20 wt % of the total electrolyte fluid.

In some variations, the amount of FEC is less than or equal to 20 wt % of the total electrolyte fluid. In some variations, the amount of FEC is less than or equal to 18 wt % of the total electrolyte fluid. In some variations, the amount of FEC is less than or equal to 16 wt % of the total electrolyte fluid. In some variations, the amount of FEC is less than or equal to 14 wt % of the total electrolyte fluid. In some variations, the amount of FEC is less than or equal to 12 wt % of the total electrolyte fluid. In some variations, the amount of FEC is less than or equal to 10 wt % of the total electrolyte fluid. In some variations, the amount of FEC is less than or equal to 8 wt % of the total electrolyte fluid. In some variations, the amount of FEC is less than or equal to 6 wt % of the total electrolyte fluid. In some variations, the amount of FEC is less than or equal to 4 wt % of the total electrolyte fluid. In some variations, the amount of FEC is less than or equal to 2 wt % of the total electrolyte fluid. In some variations, the amount of FEC is less than or equal to 1 wt % of the total electrolyte fluid.

A lower limit or upper limit of the amount of FEC can be selected separately. Alternatively, a lower and upper limit of FEC can be selected in any combination described herein.

In some variations, the amount of MMDS is at least 0.1 wt % of the total electrolyte fluid. In some variations, the amount of MMDS is at least 0.5 wt % of the total electrolyte fluid. In some variations, the amount of MMDS is at least 1.0 wt % of the total electrolyte fluid. In some variations, the amount of MMDS is at least 1.5 wt % of the total electrolyte fluid. In some variations, the amount of MMDS is at least 2.0 wt % of the total electrolyte fluid. In some variations, the amount of MMDS is at least 2.5 wt % of the total electrolyte fluid. In some variations, the amount of MMDS is at least 3.0 wt % of the total electrolyte fluid. In some variations, the amount of MMDS is at least 3.5 wt % of the total electrolyte fluid. In some variations, the amount of MMDS is at least 4.0 wt % of the total electrolyte fluid. In some variations, the amount of MMDS is at least 4.5 wt % of the total electrolyte fluid.

In some variations, the amount of MMDS is less than or equal to 5.0 wt % of the total electrolyte fluid. In some variations, the amount of MMDS is less than or equal to 4.5 wt % of the total electrolyte fluid. In some variations, the amount of MMDS is less than or equal to 4.0 wt % of the total electrolyte fluid. In some variations, the amount of MMDS is less than or equal to 3.5 wt % of the total electrolyte fluid. In some variations, the amount of MMDS is less than or equal to 3.0 wt % of the total electrolyte fluid. In some variations, the amount of MMDS is less than or equal to 2.5 wt % of the total electrolyte fluid. In some variations, the amount of MMDS is less than or equal to 2.0 wt % of the total electrolyte fluid. In some variations, the amount of MMDS is less than or equal to 1.5 wt % of the total electrolyte fluid. In some variations, the amount of MMDS is less than or equal to 1.0 wt % of the total electrolyte fluid. In some variations, the amount of MMDS is less than or equal to 0.5 wt % of the total electrolyte fluid.

A lower limit or upper limit of the amount of MMDS can be selected separately. Alternatively, a lower and upper limit of MMDS can be selected in any combination described herein.

In some variations, the amount of PES is at least 0.01 wt % of the total electrolyte fluid. In some variations, the amount of PES is at least 0.1 wt % of the total electrolyte fluid. In some variations, the amount of PES is at least 0.5 wt % of the total electrolyte fluid. In some variations, the amount of PES is at least 0.6 wt % of the total electrolyte fluid. In some variations, the amount of PES is at least 0.9 wt % of the total electrolyte fluid. In some variations, the amount of PES is at least 1.3 wt % of the total electrolyte fluid. In some variations, the amount of PES is at least 1.6 wt % of the total electrolyte fluid. In some variations, the amount of PES is at least 1.9 wt % of the total electrolyte fluid. In some variations, the amount of PES is at least 2.2 wt % of the total electrolyte fluid. In some variations, the amount of PES is at least 2.5 wt % of the total electrolyte fluid. In some variations, the amount of PES is at least 2.8 wt % of the total electrolyte fluid. In some variations, the amount of PES is at least 3.1 wt % of the total electrolyte fluid. In some variations, the amount of PES is at least 3.5 wt % of the total electrolyte fluid. In some variations, the amount of PES is at least 4.0 wt % of the total electrolyte fluid. In some variations, the amount of PES is at least 4.5 wt % of the total electrolyte fluid.

In some variations, the amount of PES is less than or equal to 5.0 wt % of the total electrolyte fluid. In some variations, the amount of PES is less than or equal to 4.5 wt % of the total electrolyte fluid. In some variations, the amount of PES is less than or equal to 4.0 wt % of the total electrolyte fluid. In some variations, the amount of PES is less than or equal to 3.5 wt % of the total electrolyte fluid. In some variations, the amount of PES is less than or equal to 3.1 wt % of the total electrolyte fluid. In some variations, the amount of PES is less than or equal to 2.8 wt % of the total electrolyte fluid. In some variations, the amount of PES is less than or equal to 2.5 wt % of the total electrolyte fluid. In some variations, the amount of PES is less than or equal to 2.2 wt % of the total electrolyte fluid. In some variations, the amount of PES is less than or equal to 1.9 wt % of the total electrolyte fluid. In some variations, the amount of PES is less than or equal to 1.6 wt % of the total electrolyte fluid. In some variations, the amount of PES is less than or equal to 1.3 wt % of the total electrolyte fluid. In some variations, the amount of PES is less than or equal to 1.1 wt % of the total electrolyte fluid. In some variations, the amount of PES is less than or equal to 0.9 wt % of the total electrolyte fluid. In some variations, the amount of PES is less than or equal to 0.6 wt % of the total electrolyte fluid. In some variations, the amount of PES is less than or equal to 0.4 wt % of the total electrolyte fluid. In some variations, the amount of PES is less than or equal to 0.10 wt % of the total electrolyte fluid. In some variations, the amount of PES is less than or equal to 0.05 wt % of the total electrolyte fluid.

A lower limit or upper limit of the amount of PES can be selected separately. Alternatively, a lower and upper limit of PES can be selected in any combination described herein.

In some variations, the amount of PS is at least 0.5 wt % of the total electrolyte fluid. In some variations, the amount of PS is at least 1.0 wt % of the total electrolyte fluid. In some variations, the amount of PS is at least 1.5 wt % of the total electrolyte fluid. In some variations, the amount of PS is at least 2.0 wt % of the total electrolyte fluid. In some variations, the amount of PS is at least 2.5 wt % of the total electrolyte fluid. In some variations, the amount of PS is at least 3.0 wt % of the total electrolyte fluid. In some variations, the amount of PS is at least 3.5 wt % of the total electrolyte fluid. In some variations, the amount of PS is at least 4.0 wt % of the total electrolyte fluid. In some variations, the amount of PS is at least 4.5 wt % of the total electrolyte fluid. In some variations, the amount of PS is at least 5.0 wt % of the total electrolyte fluid. In some variations, the amount of PS is at least 5.5 wt % of the total electrolyte fluid. In some variations, the amount of PS is at least 6.5 wt % of the total electrolyte fluid. In some variations, the amount of PS is at least 7.0 wt % of the total electrolyte fluid. In some variations, the amount of PS is at least 7.5 wt % of the total electrolyte fluid. In some variations, the amount of PS is at least 8.0 wt % of the total electrolyte fluid. In some variations, the amount of PS is at least 8.5 wt % of the total electrolyte fluid. In some variations, the amount of PS is at least 9.0 wt % of the total electrolyte fluid. In some variations, the amount of PS is at least 9.5 wt % of the total electrolyte fluid.

In some variations, the amount of PS is less than or equal to 10.0 wt % of the total electrolyte fluid. In some variations, the amount of PS is less than or equal to 9.5 wt % of the total electrolyte fluid. In some variations, the amount of PS is less than or equal to 9.0 wt % of the total electrolyte fluid. In some variations, the amount of PS is less than or equal to 8.5 wt % of the total electrolyte fluid. In some variations, the amount of PS is less than or equal to 8.0 wt % of the total electrolyte fluid. In some variations, the amount of PS is less than or equal to 7.5 wt % of the total electrolyte fluid. In some variations, the amount of PS is less than or equal to 7.0 wt % of the total electrolyte fluid. In some variations, the amount of PS is less than or equal to 6.5 wt % of the total electrolyte fluid. In some variations, the amount of PS is less than or equal to 6.0 wt % of the total electrolyte fluid. In some variations, the amount of PS is less than or equal to 5.5 wt % of the total electrolyte fluid. In some variations, the amount of PS is less than or equal to 5.0 wt % of the total electrolyte fluid. In some variations, the amount of PS is less than or equal to 4.5 wt % of the total electrolyte fluid. In some variations, the amount of PS is less than or equal to 4.0 wt % of the total electrolyte fluid. In some variations, the amount of PS is less than or equal to 3.5 wt % of the total electrolyte fluid. In some variations, the amount of PS is less than or equal to 3.0 wt % of the total electrolyte fluid. In some variations, the amount of PS is less than or equal to 2.5 wt % of the total electrolyte fluid. In some variations, the amount of PS is less than or equal to 2.0 wt % of the total electrolyte fluid. In some variations, the amount of PS is less than or equal to 1.5 wt % of the total electrolyte fluid. In some variations, the amount of PS is less than or equal to 1.0 wt % of the total electrolyte fluid.

A lower limit or upper limit of the amount of PS can be selected separately. Alternatively, a lower and upper limit of PS can be selected in any combination described herein.

In some variations, LiDFOB is at least 0.1 wt % of the total electrolyte fluid. In some variations, LiDFOB is at least 0.2 wt % of the total electrolyte fluid. In some variations, LiDFOB is at least 0.3 wt % of the total electrolyte fluid. In some variations, LiDFOB is at least 0.4 wt % of the total electrolyte fluid. In some variations, LiDFOB is at least 0.5 wt % of the total electrolyte fluid. In some variations, LiDFOB is at least 0.6 wt % of the total electrolyte fluid. In some variations, LiDFOB is at least 0.7 wt % of the total electrolyte fluid. In some variations, LiDFOB is at least 0.8 wt % of the total electrolyte fluid. In some variations, LiDFOB is at least 0.9 wt % of the total electrolyte fluid. In some variations, LiDFOB is at least 1.0 wt % of the total electrolyte fluid. In some variations, LiDFOB is at least 1.3 wt % of the total electrolyte fluid. In some variations, LiDFOB is at least 1.6 wt % of the total electrolyte fluid. In some variations, LiDFOB is at least 1.9 wt % of the total electrolyte fluid. In some variations, LiDFOB is at least 1.9 wt % of the total electrolyte fluid. In some variations, LiDFOB is at least 2.2 wt % of the total electrolyte fluid. In some variations, LiDFOB is at least 2.5 wt % of the total electrolyte fluid. In some variations, LiDFOB is at least 2.8 wt % of the total electrolyte fluid.

In some variations, LiDFOB is less than or equal to 3.0 wt % of the total electrolyte fluid. In some variations, LiDFOB is less than or equal to 2.7 wt % of the total electrolyte fluid. In some variations, LiDFOB is less than or equal to 2.4 wt % of the total electrolyte fluid. In some variations, LiDFOB is less than or equal to 2.1 wt % of the total electrolyte fluid. In some variations, LiDFOB is less than or equal to 1.9 wt % of the total electrolyte fluid. In some variations, LiDFOB is less than or equal to 1.6 wt % of the total electrolyte fluid. In some variations, LiDFOB is less than or equal to 1.3 wt % of the total electrolyte fluid. In some variations, LiDFOB is less than or equal to 1.1 wt % of the total electrolyte fluid. In some variations, LiDFOB is less than or equal to 1.0 wt % of the total electrolyte fluid. In some variations, LiDFOB is less than or equal to 0.9 wt % of the total electrolyte fluid. In some variations, LiDFOB is less than or equal to 0.8 wt % of the total electrolyte fluid. In some variations, LiDFOB is less than or equal to 0.7 wt % of the total electrolyte fluid. In some variations, LiDFOB is less than or equal to 0.6 wt % of the total electrolyte fluid. In some variations, LiDFOB is less than or equal to 0.5 wt % of the total electrolyte fluid. In some variations, LiDFOB is less than or equal to 0.4 wt % of the total electrolyte fluid. In some variations, LiDFOB is less than or equal to 0.3 wt % of the total electrolyte fluid. In some variations, LiDFOB is less than or equal to 0.2 wt % of the total electrolyte fluid.

A lower limit or upper limit of the amount of LiDFOB can be selected separately. Alternatively, a lower and upper limit of LiDFOB can be selected in any combination described herein.

In some variations, the amount of SN is at least 0.5 wt % of the total electrolyte fluid. In some variations, the amount of SN is at least 1.0 wt % of the total electrolyte fluid. In some variations, the amount of SN is at least 1.5 wt % of the total electrolyte fluid. In some variations, the amount of SN is at least 2.0 wt % of the total electrolyte fluid. In some variations, the amount of SN is at least 2.5 wt % of the total electrolyte fluid. In some variations, the amount of SN is at least 3.0 wt % of the total electrolyte fluid. In some variations, the amount of SN is at least 3.5 wt % of the total electrolyte fluid. In some variations, the amount of SN is at least 4.0 wt % of the total electrolyte fluid. In some variations, the amount of SN is at least 4.5 wt % of the total electrolyte fluid.

In some variations, the amount of SN is less than or equal to 5.0 wt % of the total electrolyte fluid. In some variations, the amount of SN is less than or equal to 4.5 wt % of the total electrolyte fluid. In some variations, the amount of SN is less than or equal to 4.0 wt % of the total electrolyte fluid. In some variations, the amount of SN is less than or equal to 3.5 wt % of the total electrolyte fluid. In some variations, the amount of SN is less than or equal to 3.0 wt % of the total electrolyte fluid. In some variations, the amount of SN is less than or equal to 2.5 wt % of the total electrolyte fluid. In some variations, the amount of SN is less than or equal to 2.0 wt % of the total electrolyte fluid. In some variations, the amount of SN is less than or equal to 1.5 wt % of the total electrolyte fluid. In some variations, the amount of SN is less than or equal to 1.0 wt % of the total electrolyte fluid. In some variations, the amount of SN is less than or equal to 0.5 wt % of the total electrolyte fluid.

A lower limit or upper limit of the amount of SN can be selected separately. Alternatively, a lower and upper limit of SN can be selected in any combination described herein.

In some variations, the amount of HTCN is at least 0.01 wt % of the total electrolyte fluid. In some variations, the amount of HTCN is at least 0.1 wt % of the total electrolyte fluid. In some variations, the amount of HTCN is at least 0.5 wt % of the total electrolyte fluid. In some variations, the amount of HTCN is at least 1.0 wt % of the total electrolyte fluid. In some variations, the amount of HTCN is at least 1.5 wt % of the total electrolyte fluid. In some variations, the amount of HTCN is at least 2.0 wt % of the total electrolyte fluid. In some variations, the amount of HTCN is at least 2.5 wt % of the total electrolyte fluid. In some variations, the amount of HTCN is at least 3.0 wt % of the total electrolyte fluid. In some variations, the amount of HTCN is at least 3.5 wt % of the total electrolyte fluid. In some variations, the amount of HTCN is at least 4.0 wt % of the total electrolyte fluid. In some variations, the amount of HTCN is at least 4.5 wt % of the total electrolyte fluid.

In some variations, the amount of HTCN is less than or equal to 5.0 wt % of the total electrolyte fluid. In some variations, the amount of HTCN is less than or equal to 4.5 wt % of the total electrolyte fluid. In some variations, the amount of HTCN is less than or equal to 4.0 wt % of the total electrolyte fluid. In some variations, the amount of HTCN is less than or equal to 3.5 wt % of the total electrolyte fluid. In some variations, the amount of HTCN is less than or equal to 3.0 wt % of the total electrolyte fluid. In some variations, the amount of HTCN is less than or equal to 2.5 wt % of the total electrolyte fluid. In some variations, the amount of HTCN is less than or equal to 2.0 wt % of the total electrolyte fluid. In some variations, the amount of HTCN is less than or equal to 1.5 wt % of the total electrolyte fluid. In some variations, the amount of HTCN is less than or equal to 1.0 wt % of the total electrolyte fluid. In some variations, the amount of HTCN is less than or equal to 0.5 wt % of the total electrolyte fluid.

A lower limit or upper limit of the amount of HTCN can be selected separately. Alternatively, a lower and upper limit of HTCN can be selected in any combination described herein.

In some variations, LiBF₄ is at least 0.1 wt % of the total electrolyte fluid. In some variations, LiBF₄ is at least 0.2 wt % of the total electrolyte fluid. In some variations, LiBF₄ is at least 0.3 wt % of the total electrolyte fluid. In some variations, LiBF₄ is at least 0.4 wt % of the total electrolyte fluid. In some variations, LiBF₄ is at least 0.5 wt % of the total electrolyte fluid. In some variations, LiBF₄ is at least 0.6 wt % of the total electrolyte fluid. In some variations, LiBF₄ is at least 0.7 wt % of the total electrolyte fluid. In some variations, LiBF₄ is at least 0.8 wt % of the total electrolyte fluid. In some variations, LiBF₄ is at least 0.9 wt % of the total electrolyte fluid. In some variations, LiBF₄ is at least 1.0 wt % of the total electrolyte fluid. In some variations, LiBF₄ is at least 1.3 wt % of the total electrolyte fluid. In some variations, LiBF₄ is at least 1.6 wt % of the total electrolyte fluid. In some variations, LiBF₄ is at least 1.9 wt % of the total electrolyte fluid. In some variations, LiBF₄ is at least 1.9 wt % of the total electrolyte fluid. In some variations, LiBF₄ is at least 2.2 wt % of the total electrolyte fluid. In some variations, LiBF₄ is at least 2.5 wt % of the total electrolyte fluid. In some variations, LiBF₄ is less than or equal to 2.8 wt % of the total electrolyte fluid.

In some variations, LiBF₄ is less than or equal to 3.0 wt % of the total electrolyte fluid. In some variations, LiBF₄ is less than or equal to 2.7 wt % of the total electrolyte fluid. In some variations, LiBF₄ is less than or equal to 2.4 wt % of the total electrolyte fluid. In some variations, LiBF₄ is less than or equal to 2.1 wt % of the total electrolyte fluid. In some variations, LiBF₄ is less than or equal to 1.9 wt % of the total electrolyte fluid. In some variations, LiBF₄ is less than or equal to 1.3 wt % of the total electrolyte fluid. In some variations, LiBF₄ is less than or equal to 1.3 wt % of the total electrolyte fluid. In some variations, LiBF₄ is less than or equal to 1.1 wt % of the total electrolyte fluid. In some variations, LiBF₄ is less than or equal to 1.0 wt % of the total electrolyte fluid. In some variations, LiBF₄ is less than or equal to 0.9 wt % of the total electrolyte fluid. In some variations, LiBF₄ is less than or equal to 0.8 wt % of the total electrolyte fluid. In some variations, LiBF₄ is less than or equal to 0.7 wt % of the total electrolyte fluid. In some variations, LiBF₄ is less than or equal to 0.6 wt % of the total electrolyte fluid. In some variations, LiBF₄ is less than or equal to 0.5 wt % of the total electrolyte fluid. In some variations, LiBF₄ is less than or equal to 0.4 wt % of the total electrolyte fluid. In some variations, LiBF₄ is less than or equal to 0.3 wt % of the total electrolyte fluid. In some variations, LiBF₄ is less than or equal to 0.2 wt % of the total electrolyte fluid.

A lower limit or upper limit of the amount of LiBF₄ can be selected separately. Alternatively, a lower and upper limit of LiBF₄ can be selected in any combination described herein.

The electrolyte solvent may also have a salt dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂CF₃)₂, LiBC₄O₈, Li[PF₃(C₂CF₅)₃], and LiC(SO₂CF₃)₃. Other salts are possible, including combinations of salts.

### EXAMPLES

The Examples are provided for illustration purposes only. These examples are not intended to constrain any embodiment disclosed herein to any application or theory of operation.

### Example 1

The battery cell voltage as a function of charge time, anode potential as a function of charge time, and dQ/dV plots at formation were measured for battery cells containing the two electrolyte fluids of Table 1 were measured.

TABLE 1

| | Salt/M | Solvent wt % | | | | Additives wt % | | | | | |
|---|---|---|---|---|---|---|---|---|---|---|---|
| Electrolyte No | LiPF₆ | EC | PC | PP | EP | TFEB | FEC | PS | LiDFOB | SN | HTCN |
| Electrolyte 1 | 1.2 | 10 | 5 | 45 | 40 | | 7 | 4 | 0.5 | 2 | 3 |
| Electrolyte 2 | 1.2 | 10 | 5 | 45 | 40 | 0.3 | 7 | 4 | 0.5 | 2 | 3 |

In some variations, the strong lewis acid boron center (anion receptor) loosens the strong or dissolve them bonding of inorganic/organic SEI components.

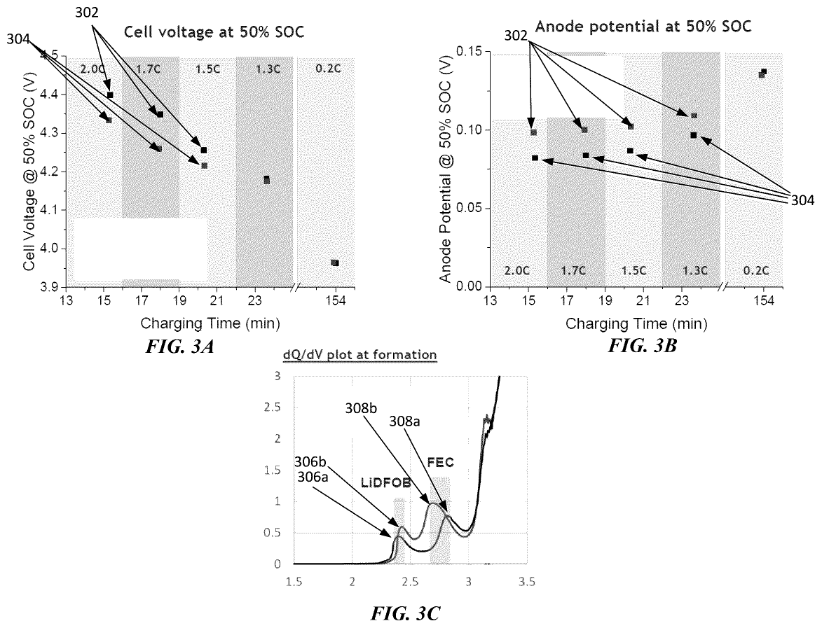

FIG. 3A depicts the full battery cell voltage at 50% state of charge (SOC) as a function of charge time for battery cells containing Electrolyte Fluid 1 (302) and Electrolyte Fluid 2 (304). Electrolyte Fluid 1 does not include TFEB, while Electrolyte Fluid 2 includes 0.3 wt % TFEB. Lower cell voltages as a function of charge time were observed with TFEB-containing Electrolyte Fluid 2 (304). The addition of TFEB thus results in lower full cell overpotential.

FIG. 3B depicts anode potential as a function of charge time for battery cells containing Electrolyte Fluid 1 (302) and Electrolyte Fluid 2 (304). Battery cells containing Electrolyte Fluid 2 (304), which includes TFEB, had a higher anode potential at 50% SOC than battery cells containing Electrolyte Fluid 1 (302), which lacked TFEB. The higher anode potential results in lower overpotential in the anode, which reduces lithium plating on the anode.

FIG. 3C depicts dQ/dV as a function of cell voltage for the formation of SEI on the graphite anode for Electrolyte Fluid 1 (302) and Electrolyte Fluid 2 (304). Peak 306a and 306b correspond to formation of a LiDFOB SEI on the graphite anode active material in the battery cell. Peak 306a corresponds to a battery cell having an Electrolyte Fluid 1 without TFEB, while peak 306b corresponds to a battery cell having Electrolyte Fluid 2 with TFEB. Peak 308a and 308b correspond to formation of a FEC SEI on the graphite anode active material in the battery cell. Peak 308a corresponds to a battery cell having an Electrolyte Fluid 1 without TFEB, while peak 308b corresponds to a battery cell having an Electrolyte Fluid 2 with TFEB. TFEB is not reduced by itself on the graphite surface.

In some variations, TFEB impact SEI formation by coordination with LiDFOB and FEC. This results in reducing the anode side overpotential.

### Example 2

The average cell voltage at 50% SOC as a function of charge time to 50% SOC, and specific discharge capacity as a function of cycle number at 25° C. and 45° C. were measured for battery cells containing the electrolyte fluids of Table 2.

TABLE 2

| | Salt/M | Solvent wt % | | | | Additives wt % | | | | | |
|---|---|---|---|---|---|---|---|---|---|---|---|
| Electrolyte No | LiPF₆ | EC | PC | PP | EP | TFEB | FEC | PS | LiDFOB | SN | HTCN |
| Electrolyte 3 | 1.2 | 15 | 5 | 40 | 40 | | 7 | 4 | 0.5 | 2 | 3 |
| Electrolyte 4 | 1.2 | 15 | 5 | 40 | 40 | 0.3 | 7 | 4 | 0.5 | 2 | 3 |

TFEB-containing formulations showed improved 15-minute full cell cycling performance with the room temperature charging protocol of Table 3 (14.4 min to 50% SOC, 19.1 min to 65% SOC). The result was lower full battery cell over-potential.

TABLE 3

Test Condition

| Step | Mode | Current | Cutoff | Voltage |
|---|---|---|---|---|
| 1 | CCCV charge | 2.2 C | 2.0 C | 4.19 V |
| 2 | CCCV charge | 2.0 C | 1.8 C | 4.33 V |
| 3 | CCCV charge | 1.8 C | 1.5 C | 4.35 V |
| 4 | CCCV charge | 1.5 C | 0.7 C | 4.43 V |
| 5 | CCCV charge | 0.7 C | 0.025 C | 4.50 V |
| 6 | CCCV charge | 0.5 C | | 3.0 V |

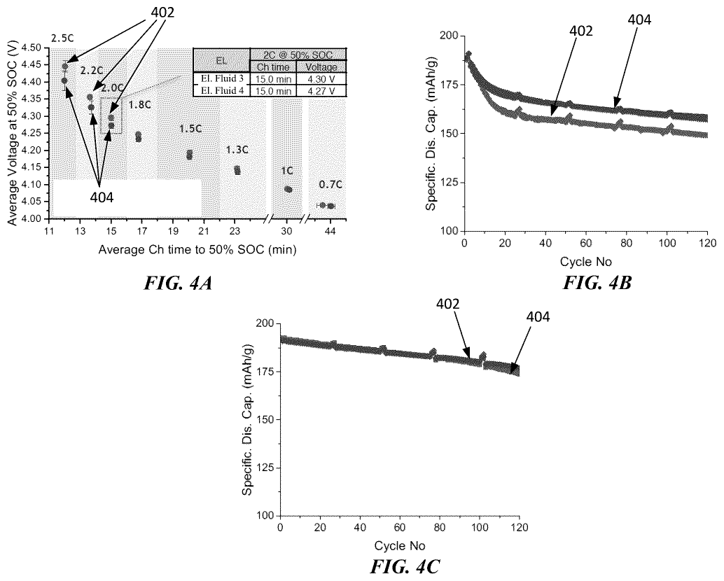

FIG. 4A depicts the average battery cell voltage at 50% SOC as a function of charge time to 50% SOC for Electrolyte Fluid 3 (402), which did not include TFEB, and Electrolyte Fluid 4 (404), which included TFEB. The addition of TFEB in Electrolyte Fluid 4 (404) results in lower average voltage as a function of charge time in battery cells than Electrolyte Fluid 5 (402).

FIG. 4B depicts the specific discharge capacity as a function of cycle number for room temperature (25° C.) fast charging cycle performance. With Electrolyte Fluid 3 (402) that lacked TFEB, 20% capacity is lost as compared to Electrolyte Fluid 4 (404), which included TFEB.

FIG. 4C depicts the specific discharge capacity as a function of cycle number for higher temperature (45° C.) fast charging cycle performance. Through approximately 80 cycles, the specific discharge capacities of battery cells containing Electrolyte Fluid 3 (402), which lacked TFEB, were roughly equivalent to battery cells containing Electrolyte Fluid 4 (404), which included TFEB. However, at cycle number 80 and higher, battery cells containing Electrolyte Fluid 4 (404) had higher specific capacity discharge.

### Example 3

The average cell voltage at 50% SOC as a function of charge time to 50% SOC, and anode potential as a function of charge time were determined for battery cells containing TFEB, DFEB, and TEB. The non-PFAS regulated compounds DFEB provided lower cell voltage and higher anode potential than TEB.

TABLE 4

| Electrolyte | Salt/M | Solvent wt % | | | | Additives wt % | | | | | | | | | |
|---|---|---|---|---|---|---|---|---|---|---|---|---|---|---|---|
| No | LiPF₆ | EC | PC | PP | EP | TFEB | DFEB | TEB | FEC | PES | PS | BS | LiDFOB | SN | HTCN |
| Electrolyte 5 | 1.2 | 15 | 5 | 25 | 55 | | | | 7 | 0.7 | 4 | 2 | 0.5 | 2 | 3 |
| Electrolyte 6 | 1.2 | 15 | 5 | 25 | 55 | 0.3 | | | 7 | 0.7 | 4 | 2 | 0.5 | 2 | 3 |
| Electrolyte 7 | 1.2 | 15 | 5 | 25 | 55 | | 0.3 | | 7 | 0.7 | 4 | 2 | 0.5 | 2 | 3 |
| Electrolyte 8 | 1.2 | 15 | 5 | 25 | 55 | | | 0.3 | 7 | 0.7 | 4 | 2 | 0.5 | 2 | 3 |

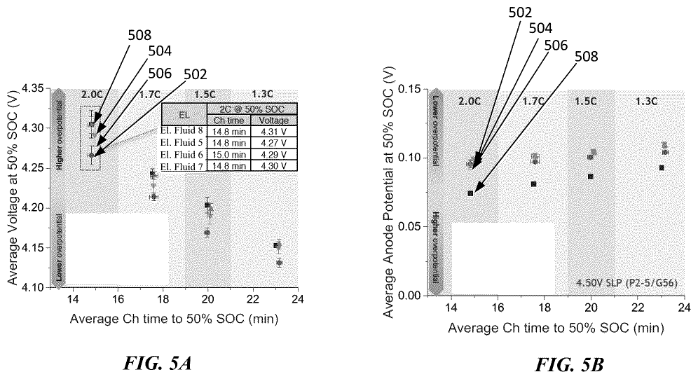

FIG. 5A depicts the full battery cell voltage at 50% state of charge (SOC) as a function of charge time of battery cells containing Electrolyte Fluid 6 (502), which include TFEB, Electrolyte Fluid 7 (504) which include DFEB, Electrolyte Fluid 5 (506), which include TEB, as compared to Electrolyte Fluid 5 (508) that did not contain any additional additive. Electrolyte Fluid 1 does not include TFEB, while Electrolyte Fluid 2 includes 0.3 wt % TFEB. Lower full battery cell voltages as a function of charge time were observed for battery cells containing TFEB-containing Electrolyte Fluid 6 (502) and DFEB-containing Electrolyte Fluid 7 (504). Battery cells containing TEB-containing electrolyte fluid 5 (506) showed a full battery cell voltage at 50% state of charge (SOC) roughly equivalent to the absence of any additional additive.

FIG. 5B depicts anode potential as a function of charge time (anode overpotential) of battery cells containing Electrolyte Fluid 6 (502), which include TFEB, Electrolyte Fluid 7 (504) which include DFEB, Electrolyte Fluid 5 (506) which include TEB, as compared to Electrolyte Fluid 5 (508) that did not contain any additional additive. The anode potential of battery cells having Electrolyte Fluids 6, 7, and 8 that TFEB (502), DFEB (504), and TEB (506), respectively, was substantially higher than battery cells including Electrolyte Fluid 5 (508) that lacked these additives.

DFEB and TEB both showed similar overpotential anode potential as TFEB. The overall cell potential reduction fell with the number of fluorines: TFEB>DFEB>TEB.

In some variations, the strong lewis acid boron center (anion receptor) reduces the strong bonding of inorganic/organic SEI components.

### Example 4

The average cell voltage at 50% SOC as a function of charge time to 50% SOC, and specific discharge capacity as a function of cycle number at 25° C. and 45° C. were measured for battery cells containing the electrolyte fluids of Tables 2 and 7.

TABLE 7

| | Salt/M | Solvent wt % | | | | Additives wt % | | | | | |
|---|---|---|---|---|---|---|---|---|---|---|---|
| Electrolyte No | LiPF₆ | EC | PC | PP | EP | DFEB | FEC | PS | LiDFOB | SN | HTCN |
| Electrolyte 9 | 1.2 | 15 | 5 | 40 | 40 | 0.3 | 7 | 4 | 0.5 | 2 | 3 |

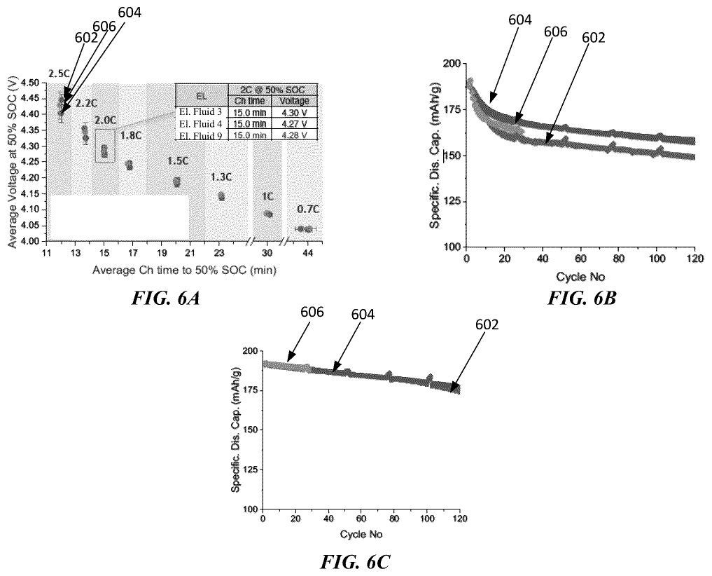

FIG. 6A depicts the average cell voltage at 50% SOC as a function of charge time to 50% SOC of battery cells containing Electrolyte Fluid 3 (602), which did not include TFEB, Electrolyte Fluid 4 (604), which included TFEB, and Electrolyte Fluid 9 (606), which includes DFEB. The addition of TFEB in Electrolyte Fluid 4 (604) results in lower average voltage as a function of charge time in battery cells than Electrolyte Fluid 5 (602). The addition of DFEB in Electrolyte Fluid 4 (606) results in lower average voltage as a function of charge time in battery cells than Electrolyte Fluid 5 (602), though not as large a reduction as Electrolyte Fluid 4 (604).

FIG. 6B depicts the specific discharge capacity as a function of cycle number for room temperature (25° C.) fast charging cycle performance of battery cells having electrolyte fluids that include TFEB, DFEB, or neither TFEB nor DFEB. With Electrolyte Fluid 3 (602) that lacked TFEB, 20% capacity is lost as compared to Electrolyte Fluid 4 (604), which included TFEB. With Electrolyte Fluid 3 (602) that also lacked DFEB, a slightly lower capacity is lost as compared to Electrolyte Fluid 4 (606), which included DFEB.

FIG. 6C depicts the specific discharge capacity as a function of cycle number for different battery cells having electrolyte fluids that include TFEB, DFEB, or neither TFEB nor DFEB at higher temperature (45° C.) fast charging cycle performance. Through approximately 80 cycles, the specific discharge capacities of battery cells containing Electrolyte Fluid 3 (602), which lacked TFEB and DFEB, were roughly equivalent to battery cells containing Electrolyte Fluid 4 (604), which included TFEB, and Electrolyte Fluid 9 (606). However, at cycle number 80 and higher, battery cells containing Electrolyte Fluid 4 (604) had higher specific capacity discharge.

### Example 5

DFEB-containing formulations showed improved discharge capacity and energy retention with the room temperature charging protocol of Table 8 (14.4 min to 50% SOC, 19.1 min to 65% SOC).

TABLE 8
Test Protocol (targeting 0-50% State of Charge, 15 minutes)

Test Condition

| Step | Mode | Current | Cutoff | Voltage |
|---|---|---|---|---|
| 1 | CCCV charge | 2.2 C | 2.0 C | 4.11 V |
| 2 | CCCV charge | 2.0 C | 1.8 C | 4.23 V |
| 3 | CCCV charge | 1.8 C | 1.5 C | 4.25 V |
| 4 | CCCV charge | 1.5 C | | 4.35 V |
| 5 | CCCV charge | 0.7 C | 0.025 C | 4.50 V |
| 6 | CCCV charge | 0.5 C | | 3.0 V |

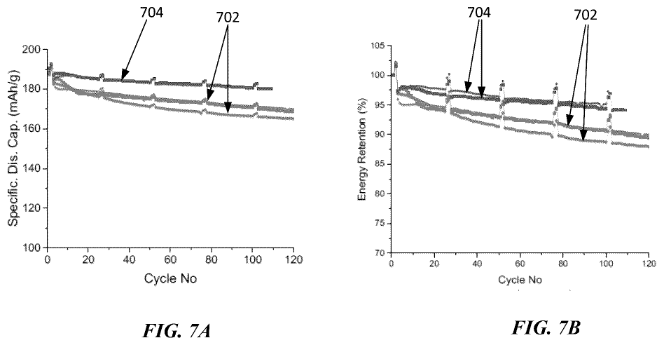

FIG. 7A depicts the specific discharge capacity as a function of cycle number following room temperature (25° C.) fast charging cycle performance for two battery cells. The first battery cell used Electrolyte 10 (702) that lacked DFEB, and the second battery cell used Electrolyte 11 (704) that included DFEB. Battery cells including Electrolyte Fluid 10 (702) that lacked TFEB showed a measurable reduction in specific discharge potential as a function of cycle number, as compared to Electrolyte Fluid 11 (704) that included DFEB.

FIG. 7B depicts energy retention as a function of cycle number following room temperature (25° C.) fast charging cycle performance for two battery cells. The first battery cell used Electrolyte 10 (702) that lacked DFEB, and the second battery cell used Electrolyte 11 (704) that included DFEB. Battery cells including Electrolyte Fluid 10 (702) that lacked TFEB showed a measurable reduction in specific discharge potential as a function of cycle number, as compared to Electrolyte Fluid 11 (704) that included DFEB.

TABLE 9

| | Salt/M | Solvent wt % | | | | Additives wt % | | | | | |
|---|---|---|---|---|---|---|---|---|---|---|---|
| Electrolyte No | LiPF₆ | EC | PC | PP | EP | DFEB | FEC | PS | LiDFOB | SN | HTCN |
| Electrolyte 10 | 1.2 | 10 | 5 | 40 | 45 | | 7 | 4 | 0.5 | 2 | 3 |
| Electrolyte 11 | 1.2 | 10 | 5 | 40 | 45 | 0.3 | 7 | 4 | 0.5 | 2 | 3 |

The electrolyte fluids described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. It will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electrolyte fluid comprising at least 0.01 wt % of a compound selected from Formula (I), Formula (II), Formula (III), Formula (IV), and a combination thereof:

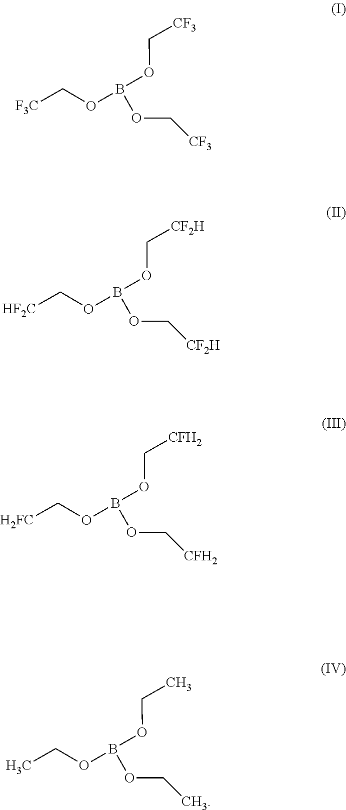

2. The electrolyte fluid of claim 1, wherein the compound is the compound of Formula (I).

3. The electrolyte fluid of claim 1, further comprising fluoroethylene carbonate (FEC) and lithium difluoro (oxalato) borate (LiDFOB).

4. The electrolyte fluid of claim 2, further comprising FEC and LiDFOB.

5. The electrolyte fluid of claim 1, wherein the electrolyte fluid excludes propane sultone (PS) and methylene methanedisulfonate (MMDS).

6. The electrolyte fluid of claim 2, wherein the electrolyte fluid excludes PS and MMDS.

7. The electrolyte fluid of claim 1, wherein the compound is the compound of Formula (II).

8. The electrolyte fluid of claim 1, wherein the compound is the compound of Formula (III).

9. The electrolyte fluid of claim 1, wherein the compound is the compound of Formula (IV).

10. The electrolyte fluid of claim 1, comprising an electrolyte salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

11. The electrolyte fluid of claim 10, wherein the electrolyte salt is LiPF₆.

12. The electrolyte fluid of one of claim 11, wherein the concentration of the electrolyte salt is from 0.8 M to 1.6 M.

13. The electrolyte fluid of claim 1, comprising a solvent selected from propylene carbonate (PC), fluoroethylene carbonate (FEC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), and butyl acetate (BA), and a combination thereof.

14. The electrolyte fluid of claim 13, wherein the solvent is selected from PC, EC, PP, EP, and a combination thereof.

15. The electrolyte fluid of claim 13, wherein the solvent comprises PC, EC, PP, and EP.

16. The electrolyte fluid of claim 13, wherein PC is from 2 to 20 wt % of the total electrolyte fluid, EC is from 5 to 40 wt % of the total electrolyte fluid, PP is from 20 to 70 wt % of the total electrolyte fluid, and/or EP is from 10 to 50 wt % of the total electrolyte fluid.

17. The electrolyte fluid of claim 1, comprising an additive selected from lithium fluoroethylene carbonate (FEC), methylene methanedisulfonate (MMDS), pro-1-ene-1, 3-sultone (PES), propane sultone (PS), lithium difluoro (oxalato) borate (LiDFOB), succinonitrile (SN), 1,3,6-hexanetricarbonitrile (HTCN), and a combination thereof.

18. The electrolyte fluid of claim 17, wherein the additive is selected from PS, FEC, SN, LiDFOB, HTCN, and a combination thereof.

19. The electrolyte fluid of claim 18, wherein the additive comprises PS, FEC, SN, LiDFOB, and HTCN.

20. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
the electrolyte fluid of claim 1 disposed between the cathode and anode.
